(19) United States
(12) Patent Application Publication
(10) Pub. No.: US 2012/0215963 A1
(43) Pub. Date: Aug. 23, 2012

(54) Semiconductor Memory Systems that Include Data Randomizers and Related Devices, Controllers and Methods

(75) Inventors: Yong June KIM, Seoul (KR); Jung Soo CHUNG, Seoul (KR); Jun Jin KONG, Yongin-si (KR); Kyoung Lae CHO, Yongin-si (KR)

(73) Assignee: Samsung Electronics Co., Ltd.

(21) Appl. No.: 13/303,512

(22) Filed: Nov. 23, 2011

(30) Foreign Application Priority Data
Feb. 21, 2011 (KR) 10-2011-0015032

(51) Int. Cl. G06F 12/00; G06F 12/02

(52) U.S. Cl. 711/103; 711/154; 711/E12.001; 711/E12.008

(57) ABSTRACT

A semiconductor memory system and a programming method performed by the same. The semiconductor memory system includes: a semiconductor memory device having a storage area; a memory controller for controlling programming and reading of the storage area of the semiconductor memory device; at least one first randomizer for changing program data to be programmed into the storage area to first random data by using a first sequence in a first period; and at least one second randomizer for changing the first random data to second random data by using a second sequence in a second period that is different from the first period.

### CROSS-REFERENCE TO RELATED APPLICATION

This application claims the benefit under 35 U.S.C. §119 of Korean Patent Application No. 10-2011-0015032, filed on Feb. 21, 2011 in the Korean Intellectual Property Office, the disclosure of which is incorporated herein in its entirety by reference.

### BACKGROUND

The inventive concept relates to semiconductor memory systems and to data randomization methods performed by such systems, and more particularly, to semiconductor memory systems that may have increased two-dimensional (2D) randomness and to methods of programming semiconductor memory devices to have such increased 2D randomness.

In order to standardize a coupling phenomenon between memory cells in a semiconductor memory device, data to be programmed into the semiconductor memory device may be randomized. Data randomizers may be used to perform such data randomization.

### SUMMARY

The inventive concept provides semiconductor memory systems that may increase randomness in both row and column directions, and related methods of programming semiconductor memory devices.

According to an aspect of the inventive concept, there is provided a semiconductor memory system that has a storage area, the semiconductor memory system including: a first randomizer that is configured to change program data to first random data using a first sequence that has a first period; and a second randomizer that is configured to change the first random data to second random data using a second sequence that has a second period that is different from the first period.

In some embodiments, the memory controller may include the first randomizer, and the semiconductor memory device may include the second randomizer. In other embodiments, the memory controller may include both the first and second randomizers. In still other embodiments, the semiconductor memory device may include both the first and second randomizers.

The first period may be longer than the second period. Alternatively, the first period may be shorter than the second period.

A plurality of first randomizers may be included in the semiconductor memory system. Alternatively or additionally, a plurality of second randomizers may be included in the semiconductor memory system.

The first randomizer may be a binary randomizer for generating the first sequence from a first seed, and the second randomizer may also be a binary randomizer for generating the second sequence from a second seed.

The first and second seeds may be different from each other. Alternatively, the first and second seeds may be the same.

According to another aspect of the inventive concept, there is provided a semiconductor memory device including: a first randomizer for generating first random data by randomizing program data to be programmed with a first sequence in a first period; and a second randomizer for generating second random data by randomizing the first random data with a second sequence in a second period that is different from the first period and providing the second random data to a memory cell array.

According to another aspect of the inventive concept, there is provided a semiconductor memory device including a randomizer that is configured to receive first random data that is obtained by randomizing program data using a first sequence that has a first period and to change the received first random data to second random data using a second sequence that has a second period that is different from the first period.

According to another aspect of the inventive concept, there is provided a semiconductor memory system that includes a memory controller that has a first randomizer that is configured to change program data to first random data using a first sequence that has a first period and a NAND flash memory device that includes second randomizer that is configured to change the first random data to second random data using a second sequence that has a second period.

The first and second periods may be the same. Alternatively, the first and second periods may be different from each other.

### BRIEF DESCRIPTION OF THE DRAWINGS

Exemplary embodiments of the inventive concept will be more clearly understood from the following detailed description taken in conjunction with the accompanying drawings in which:

FIG. 1A is a block diagram of a semiconductor memory system according to embodiments of the inventive concept, and FIG. 1B is a flowchart illustrating a programming method performed by the semiconductor memory system of FIG. 1A;

FIGS. 2A through 2C are diagrams for describing a structure and operations of a memory cell array of the semiconductor memory system of FIG. 1A;

FIGS. 3A and 3B are block diagrams of linear feedback shift registers that may be used to implement the randomizers that are included in the memory systems according to embodiments of the inventive concept.

FIGS. 4A and 4B are block diagrams of the first randomizer and the second randomizer, respectively, that are included in the semiconductor memory system of FIG. 1A;

FIGS. 5A and 5B are block diagrams of an alternative multiplicative randomizer and a multiplicative derandomizer, respectively, that may be used to implement the randomizers and derandomizers that are included in the semiconductor memory systems according to embodiments of the inventive concept.

FIGS. 6 through 14 are block diagrams of semiconductor memory systems according to further embodiments of the inventive concept;

FIG. 15 is a block diagram of a semiconductor memory system according to still further embodiments of the inventive concept that includes a plurality of semiconductor memory devices;

FIG. 16 is a block diagram of a computing system that includes one of the semiconductor memory systems according to embodiments of the inventive concept;

FIG. 17 is a schematic diagram of a memory card that includes one of the semiconductor memory systems according to embodiments of the inventive concept; and

FIG. 18 is a block diagram of a solid state drive (SSD) that includes one of the semiconductor memory systems according to embodiments of the inventive concept.

### DETAILED DESCRIPTION OF THE EMBODIMENTS

The attached drawings illustrate exemplary embodiments of the inventive concept and are referred to in order to provide an understanding of these embodiments, the merits thereof, and various objectives that may be accomplished by the implementations of the exemplary embodiments.

Hereinafter, certain exemplary embodiments will be described in detail with reference to the attached drawings. Like reference numerals in the drawings denote like elements.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this disclosure and the relevant art and will not be interpreted in an idealized or overly formal sense unless expressly so defined herein.

All embodiments can be combined in any way and/or combination.

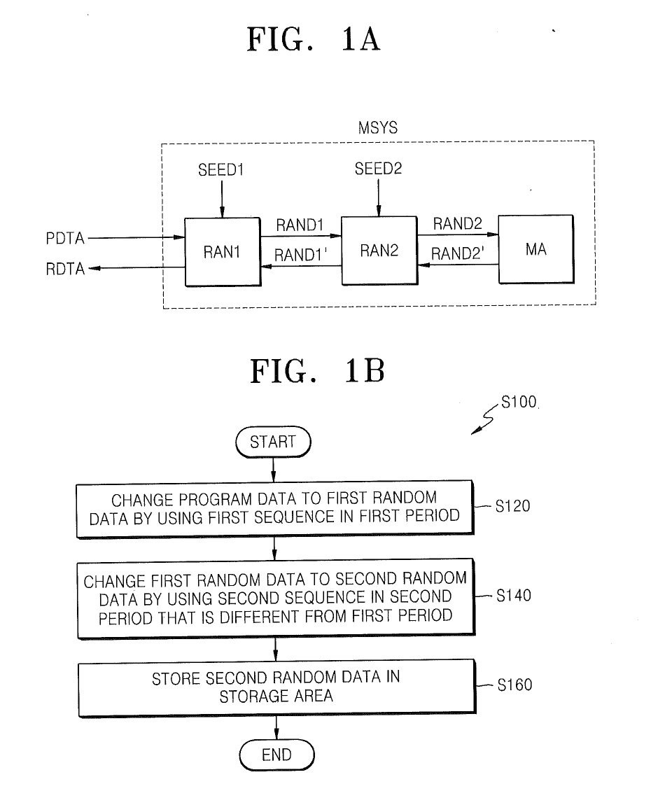

FIG. 1A is a block diagram of a semiconductor memory system MSYS according to certain embodiments of the inventive concept. FIG. 1B is a flowchart illustrating a programming method S100 that may be performed by the semiconductor memory system MSYS of FIG. 1A.

Referring to FIG. 1A, a first randomizer RAN1 of the semiconductor memory system MSYS generates first random data RAND1 by randomizing input program data PDTA. The input program data PDTA may be data that is to be stored in a memory cell array MA (or other storage area) of the semiconductor memory system MSYS. Herein, the term “randomizing” refers to a randomizing operation that randomly resets bit values of original data such as the input program data PDTA. As shown at operation S120 of FIG. 1B, the first randomizer RAN1 uses a first sequence to change the program data PDTA to first random data RAND1. The semiconductor memory system MSYS includes a second randomizer RAN2 that generates second random data RAND2 by randomizing the first random data RAND1. In particular, the second randomizer RAN2 uses a second sequence to change the first random data RAND1 to the second random data RAND2, as noted in operation S140 of FIG. 1B. The second random data RAND2 is provided to the memory cell array MA of the semiconductor memory system MSYS, as noted in operation S160 of FIG. 1B.

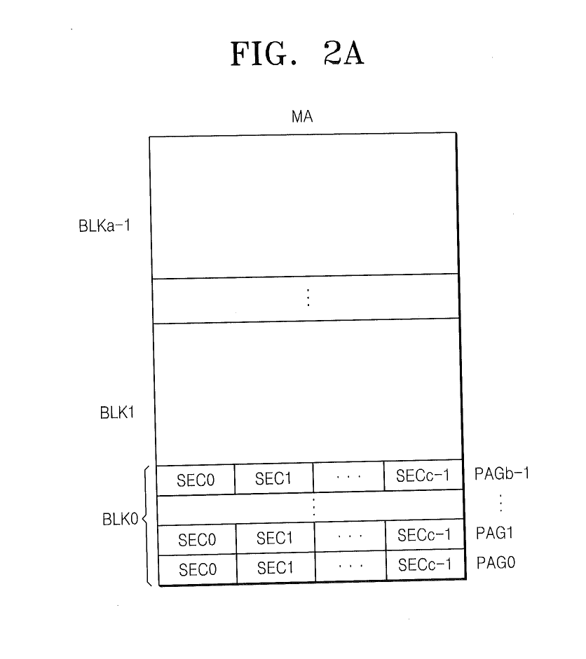

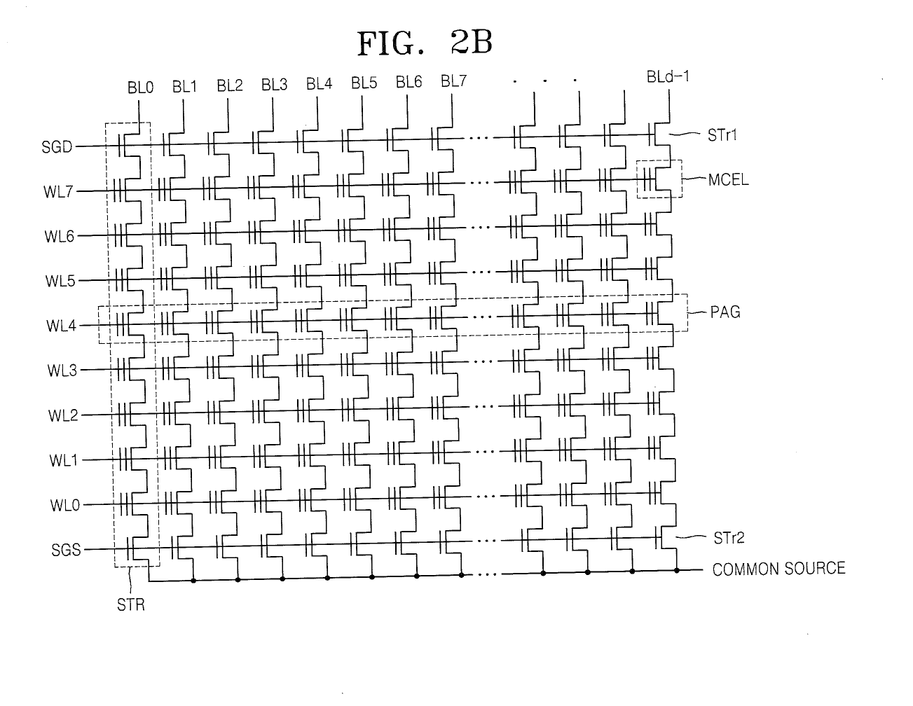

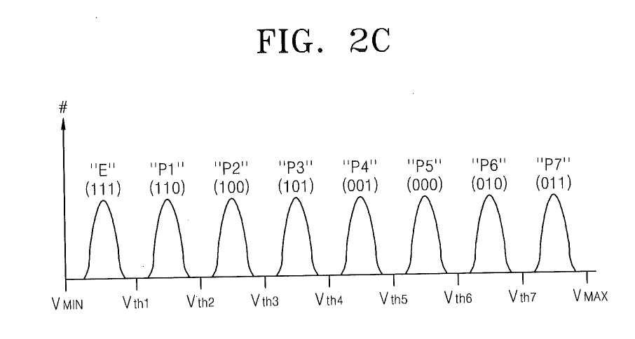

In some embodiments, the memory cell array MA may have the structure shown in FIG. 2A. In detail, the memory cell array MA may include blocks BLKO through BLKa-1, where a is an integer that is greater than or equal to 2. Each of the blocks BLK0 through BLKa-1 may include b pages PAG0 through PAGb-1, where b is an integer that is greater than or equal to 2. Each of the pages PAG0 through PAGb-1 may include c sectors SEC0 through SECc-1, where c is an integer that is greater than or equal to 2. To simplify the drawings, FIG. 2A only shows pages PAG0 through PAGb-1 and sectors SEC0 through SECc-1 for block BLK0. It will be understood, however, that blocks BLK1 through BLKa-1 may have the same structure as block BLK0.

In some embodiments, the memory cell array MA may be a memory cell array of a NAND flash memory device. In such embodiments, the blocks BLK0 through BLKa-1 of FIG. 2A may have the structure shown in FIG. 2B. Referring to FIG. 2B, each of the blocks BLK0 through BLKa-1 may include d strings STR, where d may be an integer that is greater than or equal to 2. Each string STR may include, for example, 8 memory cells MCEL that are connected in series in a direction of the bit lines BL0 through BLd-1. Each string STR may also include a drain selecting transistor STR1 and a source selecting transistor STR2, which are respectively connected in series to each end of the memory cells MCEL that are included in the string STR.

The NAND flash memory device having the structure of FIG. 2B performs an erase operation in a block unit (i.e., all of the memory cells MCEL of a block are erased at the same time), and performs a program operation in a page PAG unit (i.e., all of the memory cells MCEL of a page PAG are programmed at the same time). As shown in FIG. 2B, each of the word lines WL0 through WL7 define a page unit PAG. In the embodiment of FIG. 2B, 8 pages PAG are included per block, with each page PAG corresponding to a respective one of the 8 word lines WL0 through WL7. However, it will be appreciated that the blocks BLK0 through BLKa-1 of the memory cell array MA may include different numbers of memory cells per page and/or different numbers of pages per block than are shown in the particular embodiment illustrated in FIG. 2B.

In FIG. 1A, the illustrated semiconductor memory system MSYS includes only one memory cell array MA in order to simplify the drawings and description. However, it will be appreciated that the semiconductor memory system MSYS may include a plurality of memory cell arrays that have, for example, the same structure and perform the same operations as the memory cell array MA described above.

Each memory cell MCEL included in the memory device of FIG. 2B may have a threshold voltage Vth having one of distributions shown in FIG. 2C, where each threshold voltage distribution corresponds to a stored data value, such as “111”, “110”, “100”, “101”, “001”, “000”, “010”, or “011”. The threshold voltage distributions illustrated in FIG. 2C may be used, for example, as the distributions for a 3-bit multilevel cell (MLC) flash memory device. In other words, FIG. 2C shows threshold voltage Vth distributions for eight different states (stored data values) E and P1 through P7 of memory cell MCEL according to a 3-bit data value.

As semiconductor memory devices become more highly integrated, the physical distance between adjacent memory cells MCEL (see FIG. 2B) generally decreases. Moreover, the number of states (refer to FIG. 2C) that each memory cell MCEL may be programmed to may be greater than two. As the spacing between adjacent memory cells is reduced and/or the number of states increased, a coupling phenomenon that may occur between adjacent memory cells in the same string, or between adjacent memory cells in the same page may be increased. Also, a back pattern dependency (BPD) phenomenon may occur which refers to distortion in a memory cell that may be caused by changes in the conduction properties of other memory cells in the same string, which may result in an artificial shift in the storage value read from the memory cell at issue. When a size of a corresponding read voltage and a size of a threshold voltage of a memory cell near the edge of a cell distribution change due to such coupling phenomenon and/or BPD phenomenon, a semiconductor memory system may read stored data incorrectly. However, the semiconductor memory systems according to embodiments of the inventive concept may increase randomness of data stored in a memory cell array MA in both the bit line direction (string direction) and the word line direction (page direction) via randomizing, which may reduce the possibility that data may be read incorrectly because of the coupling phenomenon and/or the BPD phenomenon.

Referring back to FIG. 1A, the first and second randomizers RAN1 and RAN2 of the semiconductor memory system MSYS perform randomizing by using sequences having different periods, which may increase randomness of the stored data in both the bit line and the word line directions. This randomizing operation will now be described in detail.

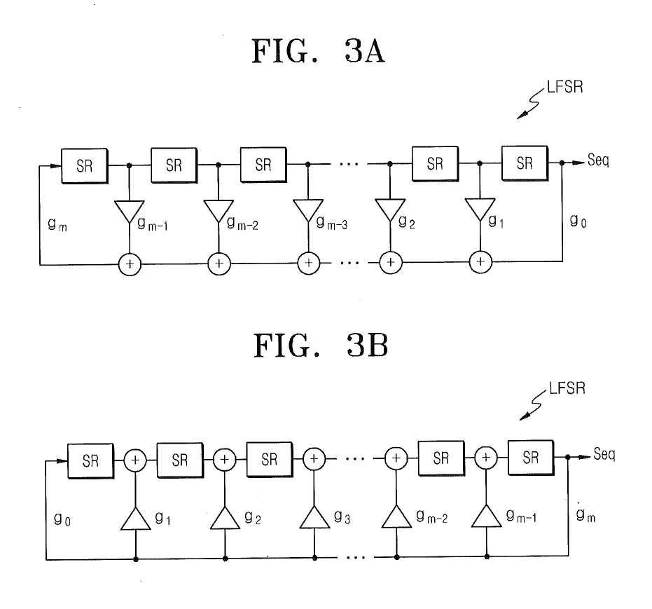

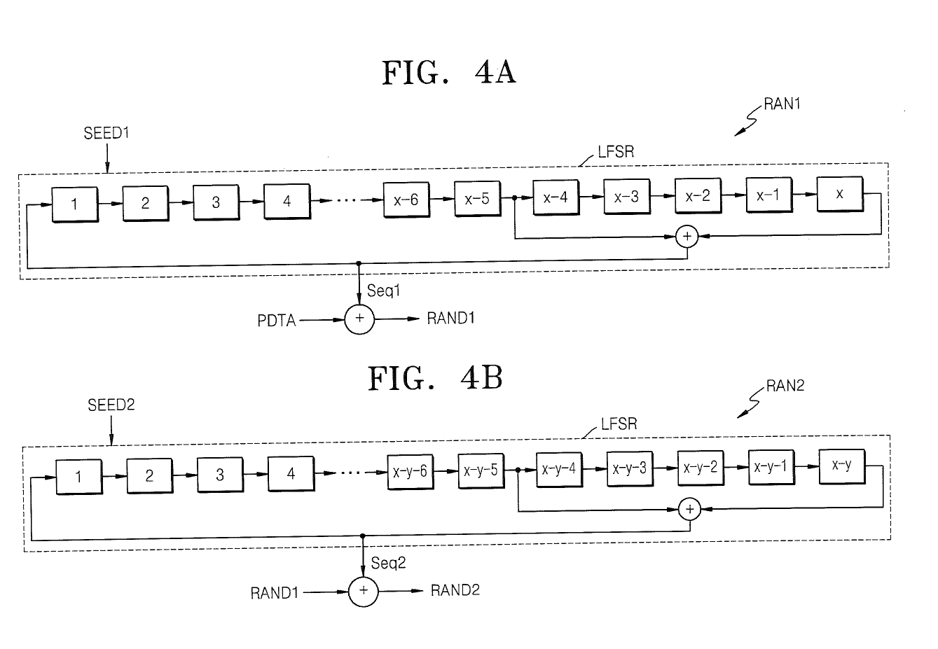

Each of the first and second randomizers RANI and RAN2 may include a linear feedback shift register (LFSR) that acts as a binary randomizer. Each LFSR may includes m shift registers SR (where m is an integer that is greater than or equal to 2) such as, for example, the Fibonacci LFSR shown in FIG. 3A or the Galois LFSR shown in FIG. 3B. For convenience of description, the Fibonacci LFSR of FIG. 3A is used to describe FIGS. 4A, 4B, etc.

The LFSRs of FIGS. 3A and 3B may be represented by g(z) of Equation 1 below.

g(z)=gₘ*z^{m}+gₘ₋₁*z^{m-1}+ . . . +g₁*z¹+g₀ [Equation 1]

Generally, a primitive polynomial is recommended to be used for g(z) in Equation 1. When a primitive polynomial is used, a period L(Seq) of an output sequence Seq of an LFSR that includes m shift registers SR is represented by Equation 2 below.

L(Seq)=2^{m}−1 [Equation 2]

The first and second randomizers RAN1 and RAN2 including any of the LFSRs of FIGS. 3A and 3B may be respectively realized as FIGS. 4A and 4B. As shown in FIG. 4A, the first randomizer RAN1 may generate a first sequence Seq1 in a first period from a first seed SEED1. The first randomizer RAN1 may include x shift registers 1 through x that are connected in series, where x is an integer that is greater than or equal to 2. The first sequence Seq1 may be obtained by performing an exclusive OR (XOR) operation on an output of the shift register x that is at the end of the series of shift registers 1 through x, and an output of a predetermined shift register, such as for example, the register x-5. The first sequence Seq1 that is generated via this XOR operation is fed back to the shift register 1 that is the first shift register in the series of shift registers 1 through x. The outputs of the shift register x and the predetermined shift register x-5, on which the XOR operation is performed, may be set according to a degree of randomness required from the first randomizer RAN1.

Since the first sequence Seq1 of the first randomizer RAN1 of FIG. 4A is an output of an LFSR, if the LFSR of the first randomizer RAN1 is represented as a primitive polygonal of Equation 3 below, a period L(seq1) of the first sequence Seq1 may be represented by Equation 4 below. In Equation 3, “a” is a constant.

g(x)=gₓ*z^{z}+gₓ₋₁*z^{x-1}+ . . . +g₁*z¹+a [Equation 3]

L(seq1)=2^{x}−1 [Equation 4]

As shown in FIG. 4B, the second randomizer RAN2 generates a second sequence Seq2 in a second period from a second seed SEED2, and generates second random data RAND2 by performing an XOR operation on the second sequence Seq2 and the first random data RAND1 provided by the first randomizer RAN1.

As shown in FIG. 4B, the second randomizer RAN2 may include x-y shift registers 1 through x-y, which are connected in series, where y may be a positive integer that is smaller than x. The second sequence Seq2 may be obtained by performing an XOR operation on an output of the shift register x-y that is at the end of the series of shift registers 1 through x-y, and an output of a predetermined one of the shift registers in the series such as, for example, the shift register x-y-5. The second sequence Seq2 may be fed back to the shift register 1 that is the first in the series of shift registers 1 through x-y. The outputs of the shift register x-y and the predetermined shift register x-y-5, on which the XOR operation is performed, may be set according to a degree of randomness required from the second randomizer RAN2.

Since the second sequence Seq2 of the second randomizer RAN2 of FIG. 4B is an output of an LFSR, if the LFSR of the second randomizer RAN2 is represented as a primitive polygonal of Equation 5 below, a period L(seq2) of the second sequence Seq2 may be represented by Equation 6 below. In Equation 5, b is a constant.

g(x-y)=g_{x-y}*z^{x-y}+g_{x-y-1}*z^{x-y}+ . . . +g₁*z¹+b [Equation 5]

Lseq2=2^{x-y}−1 [Equation 6]

In other words, the first and second randomizers RAN1 and RAN2 of FIGS. 4A and 4B may generate sequences in different periods respectively according to Equations 4 and 6.

As described above, when randomizing is performed using sequences having different lengths, the tendency for random data generated by the randomizer to repeat the same pattern or same bit values, for example, 0 or 1, may be reduced according to the lengths of the sequences. In other words, the semiconductor memory system MSYS of FIG. 1A includes first and second randomizers RAN1 and RAN2 which generate sequences having different lengths, and thus, randomness of program data programmed in the memory cell array MA may be increased. As described above, this may level a coupling phenomenon that may occur between adjacent memory cells. Thus, the probability that the semiconductor memory system MSYS will malfunction may be reduced, and thus, reliability of the semiconductor memory system MSYS is increased.

In the above description, the period of the second sequence Seq2 is shorter than the period of the first sequence Seq1 (since x>x−y), but it will be appreciated that the periods are not limited thereto. If y is a negative integer in FIG. 4B (x<x−y), the period of the second sequence Seq2 may be longer than the period of the first sequence Seq1.

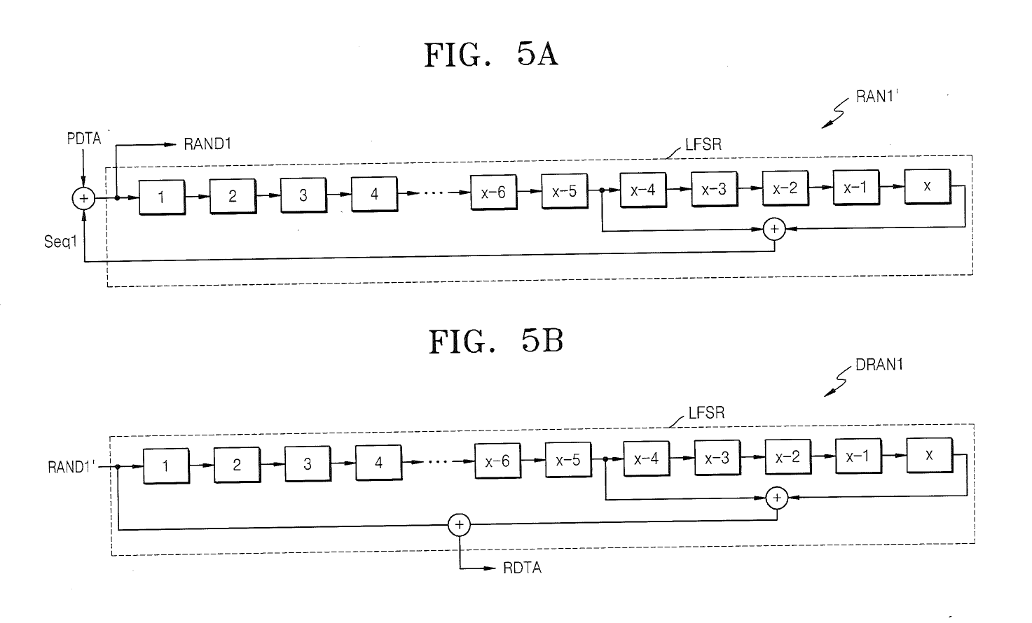

The first and second randomizers RAN1 and RAN2 of FIGS. 4A and 4B are additive type randomizers, wherein an XOR operation is performed on an input (program data PDTA) or the first random data RAND1 and an output of an LFSR, but the first and second randomizers RAN1 and RAN2 are not limited thereto. For example, as shown in FIG. 5A, a multiplicative type randomizer RAN1′ may be used to implement the first randomizer. In the multiplicative type randomizer RAN1′, an XOR operation is performed on the input program data PDTA (or the first random data RAND1 if used to implement the second randomizer) and an output of an LFSR, while an output of the randomizer RAN1′ (here the first random data RAND1) is input to the first shift register in the series of shift registers included in the LFSR.

An additive type derandomizer may be realized like the additive type randomizer. However, a multiplicative type derandomizer is realized different from the multiplicative type randomizer, as shown in FIG. 5B. While FIG. 5A illustrates the multiplicative type randomizer as it would be configured to implement the first randomizer RAN1′ (and the corresponding derandomizer DRAN1 is illustrated in FIG. 5A), it will be appreciated that a multiplicative randomizer and derandomizer could also be used to implement the second randomizer.

Referring back to FIGS. 1A and 3A, the shift registers SR of the first randomizer RAN1 may generate the first sequence Seq1 from the first seed SEED1. Similarly, the shift registers of the second randomizer RAN2 may generate the second sequence Seq2 from the second seed SEED2. In other words, while randomizing the program data PDTA, the shift registers of the first randomizer RAN1 may be initialized to the first seed SEED1 and shifted, thereby outputting the first sequence Seq1. Similarly, the shift registers of the second randomizer RAN2 may be initialized to the second seed SEED2 and shifted, thereby outputting the second sequence Seq2.

The first and second seeds SEED1 and SEED2 may be updated in a predetermined unit. For example, when the first or second randomizer RAN1 or RAN2 performs randomizing by using different seeds according to the pages PAG0 through PAGb-1, the blocks BLK0 through BLKa-1, or the sectors SEC0 through SECc-1 of FIG. 2A, the shift registers of the first or second randomizers RAN1 or RAN2 may be initialized to the first or second seed SEED1 or SEED2 corresponding to the pages PAG0 through PAGb-1, the blocks BLK0 through BLKa-1, or the sectors SEC0 through SECc-1 of FIG. 2A, whenever pages, blocks, or sectors of the program data PDTA are changed. The first and second seeds SEED1 or SEED2 may have the same or different values. For example, the first seed SEED1 may be set according to pages, and the second seed SEED2 may be set according to blocks.

As such, the first and second seeds SEED1 and SEED2 may have different forms. Hereinafter, various first and second seeds SEED1 and SEED2, and various semiconductor memory systems according to the various first and second seeds SEED1 and SEED2, according to embodiments of the inventive concept, will be described.

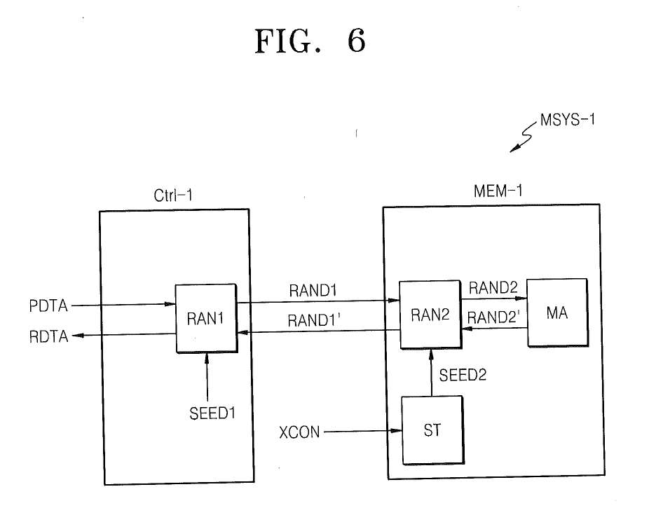

FIG. 6 is a block diagram for describing a structure and operations of the semiconductor memory system MSYS-1 according to further embodiments of the inventive concept.

Referring to FIG. 6, the semiconductor memory system MSYS-1 includes a controller Ctrl-1 and a semiconductor memory device MEM-1. The semiconductor memory device MEM-1 includes the memory cell array MA constituting a storage space for storing data. The memory cell array MA of FIG. 6 may have, for example, any one of the structures shown in FIGS. 2A and 2B. The controller Ctrl-1 controls the program data PDTA to be programmed into the memory cell array MA of the semiconductor memory device MEM-1, and read data RDTA that is read from the memory cell array MA.

Referring to the semiconductor memory system MSYS-1 of FIG. 6, the controller Ctrl-1 includes a first randomizer RANI that generates first random data RAND1 by randomizing the first sequence Seq1 and the program data PDTA in a first period. The first randomizer RAN1 of FIG. 6 may perform randomizing by using a first seed SEED1 corresponding to, for example, an external address. The semiconductor memory device MEM-1 includes a second randomizer RAN2 that generates the second random data RAND2 by randomizing the second sequence Seq2 and the first random data RAND1 in a second period. As described above, the periods of the first and second sequences Seq1 and Seq2 may be different from each other. In other words, in FIG. 6, the second randomizer RAN2 may generate the second sequence Seq2 in a period shorter than that of the first sequence Seq1 generated by the first randomizer RAN1. Alternatively, the second randomizer RAN2 may generate the second sequence Seq2 in a period longer than that of the first sequence Seq1 generated by the first randomizer RAN1.

The second randomizer RAN2 performs randomizing by using the second seed SEED2, which is stored in a seed table ST. Here, the second seed SEED2 may be provided from the seed table ST to the second randomizer RAN2 in response to a control signal XCON. In some embodiments, the control signal XCON may be provided from the controller Ctrl-1 to the seed table ST. For example, the second randomizer RAN2 may store information about a value set as an update unit, such as a block, a page, or a sector, of shift registers in the second seed SEED2, and the controller Ctrl-1 may transmit the control signal XCON to the seed table ST of the semiconductor memory device MEM-1 whenever an update is required.

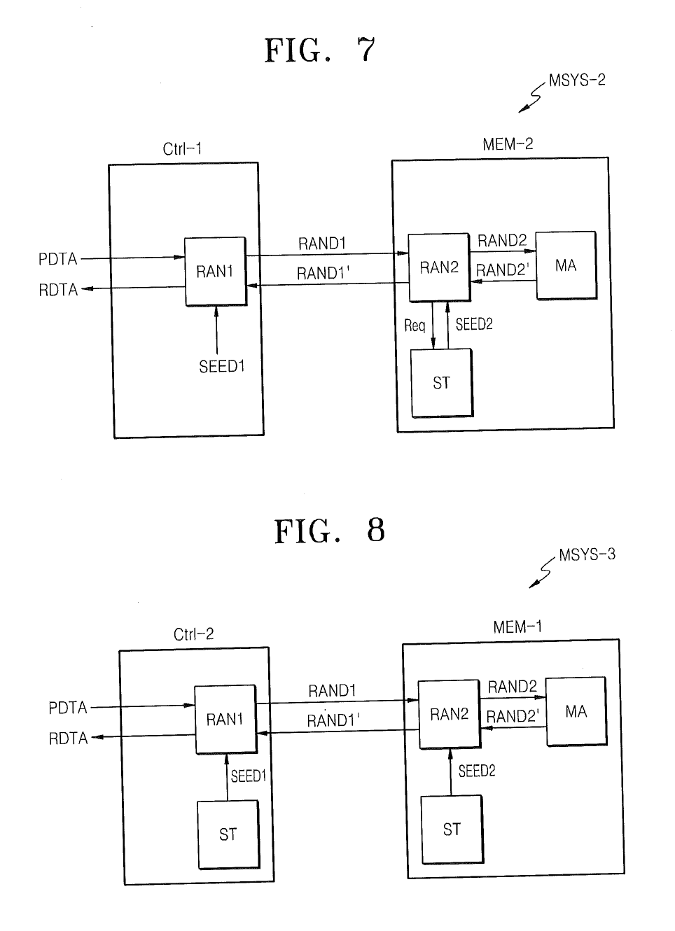

As shown in FIG. 7, according to further embodiments of the inventive concept, a semiconductor memory system MSYS-2 may be provided that includes a seed table ST that provides the second seed SEED2 to the second randomizer RAN2 in response to a request Req of the second randomizer RAN2. The second randomizer RAN2 may randomly request the second seed SEED2. Alternatively, the second randomizer RAN2 may automatically request the second seed SEED2 according to the value set as the update unit. For example, when the second randomizer RAN2 is set to update the second seed SEED2 in a page unit, the second randomizer RAN2 may request the seed table ST for the second seed SEED2 whenever a page address of data to be programmed is changed. Here, the seed table ST may have a size corresponding to the number of pages. For example, the seed table ST included in the semiconductor memory device MEM-2 (which has the memory cell array MA of FIG. 2A) may have a size obtained by multiplying a size of the second seed SEED2 by a value obtained by multiplying “a” (number of blocks) and “b” (number of pages in one block).

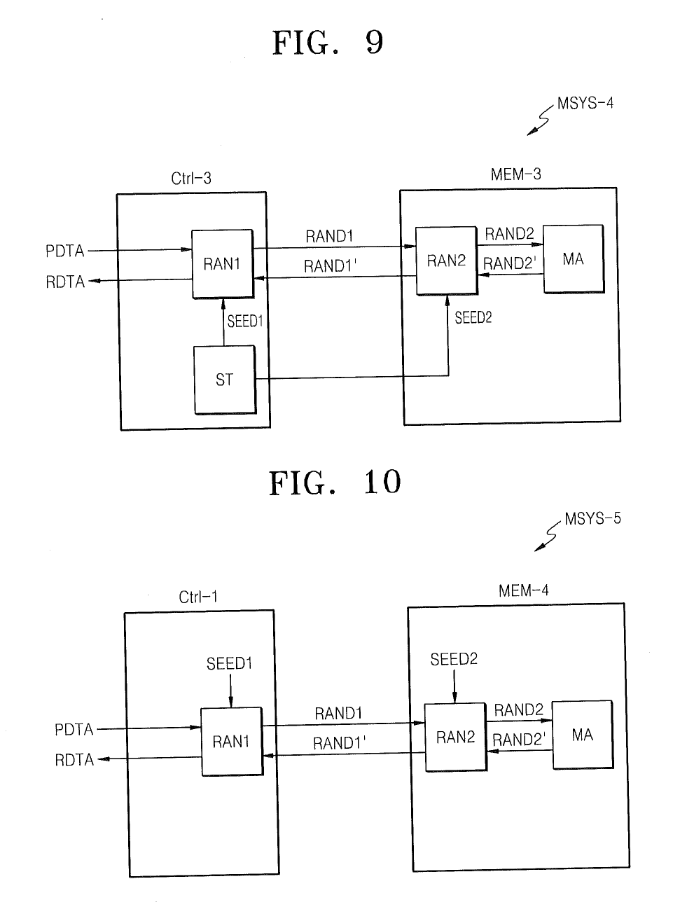

FIGS. 8 and 9 are block diagrams illustrating semiconductor memory systems according to still further embodiments of the inventive concept.

In particular, FIG. 8 depicts a semiconductor memory system MSYS-3. The semiconductor memory system MSYS-3 of FIG. 8 includes a controller Ctrl-2 that has a first randomizer RAN1 and the semiconductor memory device MEM-1, described above, that includes the second randomizer RAN2. As shown in FIG. 8, in the semiconductor memory system MSYS-3, the first seed SEED1 and second seed SEED2 are stored in separate seed tables ST. In particular, the first seed SEED1 is stored in a seed table ST that is included in the controller Ctrl-2 and the second seed SEED2 is stored in a seed table ST that is included in the semiconductor memory device MEM-1.

FIG. 9 depicts a semiconductor memory system MSYS-4 according to still further embodiments of the inventive concept that includes a controller Ctrl-3 and a semiconductor memory device MEM-3. In the embodiment of FIG. 9, a single seed table ST is used to store both the first seed SEED1 and the second seed SEED2, and this seed table ST is shared by both the controller Ctrl-3 and the semiconductor memory device MEM-3. While in the embodiment depicted in FIG. 9 the seed table ST is illustrated as being located in the controller Ctrl-3, it will be appreciated that the seed table ST could alternatively be located in the semiconductor memory device MEM-3 or at another location.

FIG. 10 is a block diagram for describing a structure and operations of the semiconductor memory system MSYS-5 according to yet further embodiments of the inventive concept.

As shown in FIG. 10, the semiconductor memory system MSYS-5 includes the controller Ctrl-1 that is included in the semiconductor memory system MSYS-1 of FIG. 6. The semiconductor memory system MSYS-5 also includes a semiconductor memory device MEM-4 that includes the second randomizer RAN2. As shown in FIG. 10, with the semiconductor memory system MSYS-5 both the first and second seeds SEED1 and SEED2 are provided from external source(s).

In the above-described embodiments of the inventive concept, a single first randomizer RAN1 and a single second randomizer RAN2 are included in the semiconductor memory systems. However, it will be appreciated that more than one first and/or second randomizers RAN1 and RAN2 may be provided. Hereinafter, first and second randomizers according to various embodiments of the inventive concept will be described. It will be appreciated that any of the exemplary techniques described above for supplying the first and second seeds SEED1 and SEED2 may be used with the first and second randomizers described below, and hence a detailed description thereof will not be repeated herein.

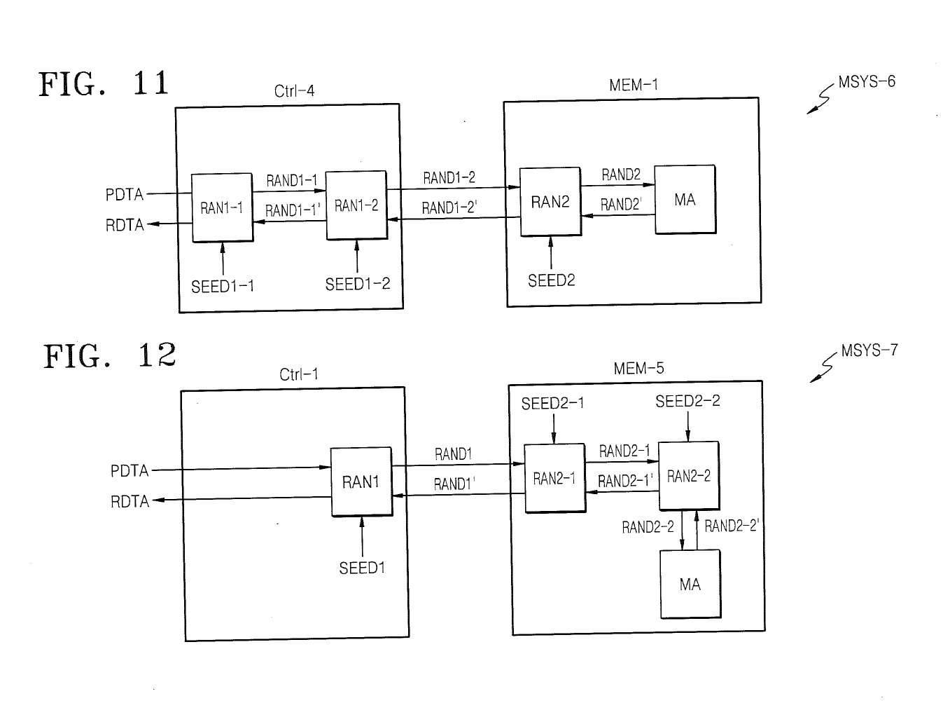

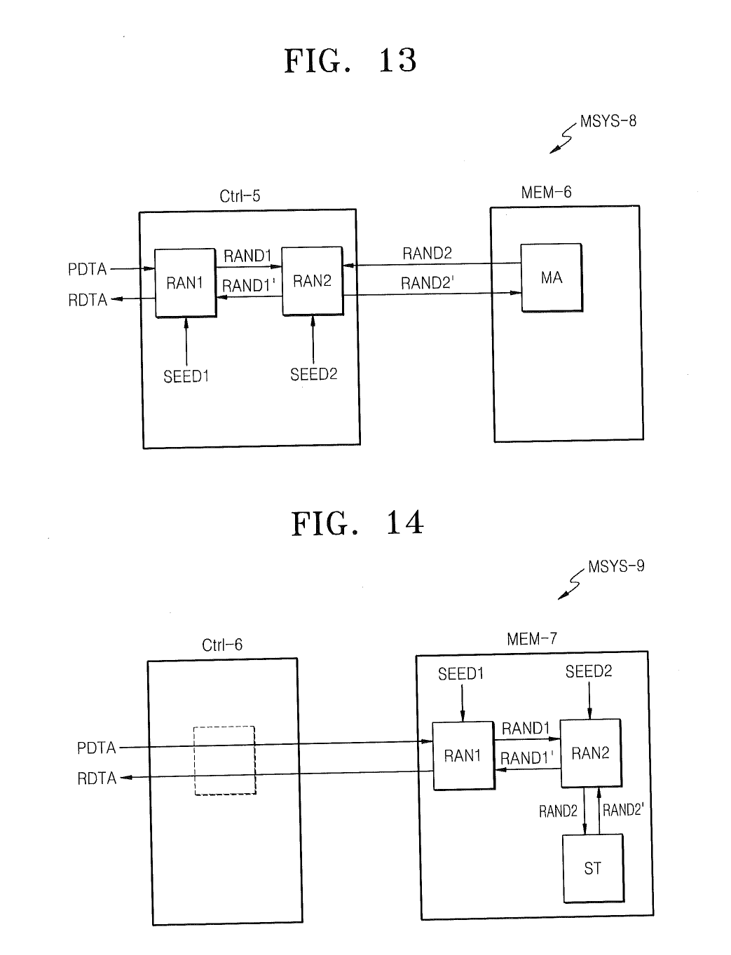

FIGS. 11 and 12 are block diagrams for describing structures and operations of semiconductor memory systems MSYS-6 and MSYS-7, respectively, according to still further embodiments of the inventive concept.

As shown in FIG. 11, the semiconductor memory system MSYS-6 includes a controller Ctrl-4 and the semiconductor memory device MEM-1 that is described above. The controller Ctrl-4 of semiconductor memory system MSYS-6 includes two first randomizers, namely a first sub-randomizer RAN1-1 and a second sub-randomizer RAN1-2. The first sub-randomizer RAN1-1 is disposed in front of the second sub-randomizer RAN1-2 so that the first sub-randomizer RAN1-1 generates first sub-random data RAND1-1 by randomizing a generated sequence and the program data PDTA, and outputs this first sub-random data RAND1-1 to the second sub-randomizer RAN1-2. The second sub randomizer RAN1-2 generates and outputs second sub-random data RAND1-2 by randomizing a generated sequence and the first sub random data RAND1-1. The first and second sub-randomizers RAN1-1 and RAN1-2 may generate the first and second sub-random data RAND1-1 and RAND1-2 by using sequences having the same period or different periods. As shown in FIG. 11, the second sub-random data RAND1-2 is provided to the second randomizer RAN2 of the semiconductor memory device MEM-1.

The semiconductor memory system MSYS-7 of FIG. 12 is similar to the semiconductor memory system MSYS-6 of FIG. 11, except that the semiconductor memory device MEM-5 that is included in semiconductor memory system MSYS-7 includes two second randomizers, i.e., first and second sub-randomizers RAN2-1 and RAN2-2, while the controller Ctrl-1 of semiconductor memory system MSYS-7 only includes a single randomizer RAN1 (as opposed to the first and second sub-randomizers RAN1-1 and RAN1-2 provided in the embodiment of FIG. 11). In the semiconductor memory system MSYS-7 of FIG. 12, the first sub-randomizer RAN2-1 generates first sub-random data RAND2-1 by randomizing a generated sequence and the first random data RAND 1. The second sub-randomizer RAN2-2 receives the first sub-random data RAND2-1 and generates and outputs second sub-random data RAND2-2 by randomizing a generated sequence and the first sub-random data RAND2-1. The first and second sub-randomizers RAN2-1 and RAN2-2 may generate the first and second sub-random data RAND2-1 and RAND2-2 by using sequences having the same period or different periods.

In the embodiments of FIGS. 11 and 12, two first randomizers RAN1 or two second randomizers RAN2 are used, but the number of first and second randomizers RAN1 and RAN2 is not limited to two. As such, it will be appreciated that any number of first and/or second randomizers RAN1 and RAN2 may be included in the semiconductor memory systems according to embodiments of the inventive concept.

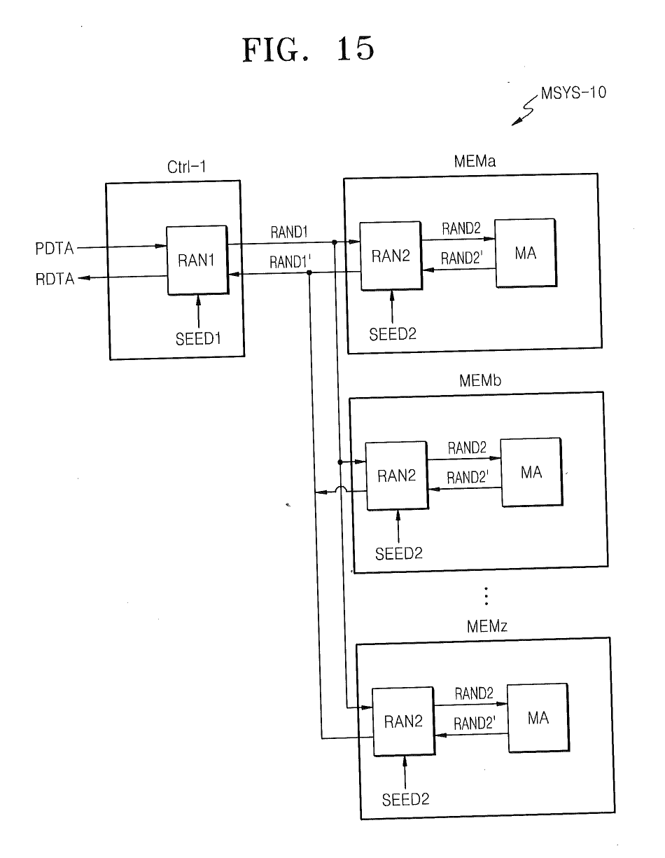

In the above-described embodiments, the controller (e.g., controllers Ctrl-1 through Ctrl-4) includes the first randomizer RAN1, and the semiconductor memory device (e.g., devices MEM-1 through MEM-5) includes the second randomizer RAN2. However, it will be appreciated that the locations of the first and second randomizers RAN1 and RAN2 are not so limited, as is illustrated with respect to the exemplary embodiments of the inventive concept depicted in FIGS. 13 and 14.

In particular, FIG. 13 illustrates a semiconductor memory system MSYS-8 according to embodiments of the inventive concept that includes a controller Ctrl-5 and a semiconductor memory device MEM-6. In the semiconductor memory system MSYS-8, both the first randomizer RAN1 and the second randomizer RAN2 are included in the controller Ctrl-5. As shown in FIG. 14, in yet another embodiment, the first and second randomizers RAN1 and RAN2 may both be implemented as part of a semiconductor memory device MEM-7. In the embodiment of FIG. 14, the controller Ctrl-6 may provide the program data PDTA through a user interface (not shown) to the semiconductor memory device MEM-7, and the read data RDTA that is read from the semiconductor memory device MEM-7 may likewise be provided to this user interface. In FIG. 14, the element for interfacing the program data PDTA and read data RDTA with the semiconductor memory device MEM-7 is indicated as a dashed line.

FIG. 15 is a block diagram of a semiconductor memory system MSYS-10 according to further embodiments of the inventive concept that includes a plurality of semiconductor memory devices. As shown in FIG. 15, the semiconductor memory system MSYS-10 includes the controller Ctrl-1 and a plurality of semiconductor memory devices MEMa through MEMz. The semiconductor memory system MSYS-10 may include the first and second randomizers RAN1 and RAN2 according to any one of the various embodiments described above. In the particular embodiment depicted in FIG. 15, the controller Ctrl-1 includes the first randomizer RAN1 and each of the semiconductor memory devices MEMa through MEMz includes a second randomizer RAN2.

As described above, the first or second seed SEED1 or SEED2 may be set to a value corresponding to blocks, pages, or sectors, or set to a value corresponding to the semiconductor memory devices MEM1 through MEMz such as, for example, a chip address.

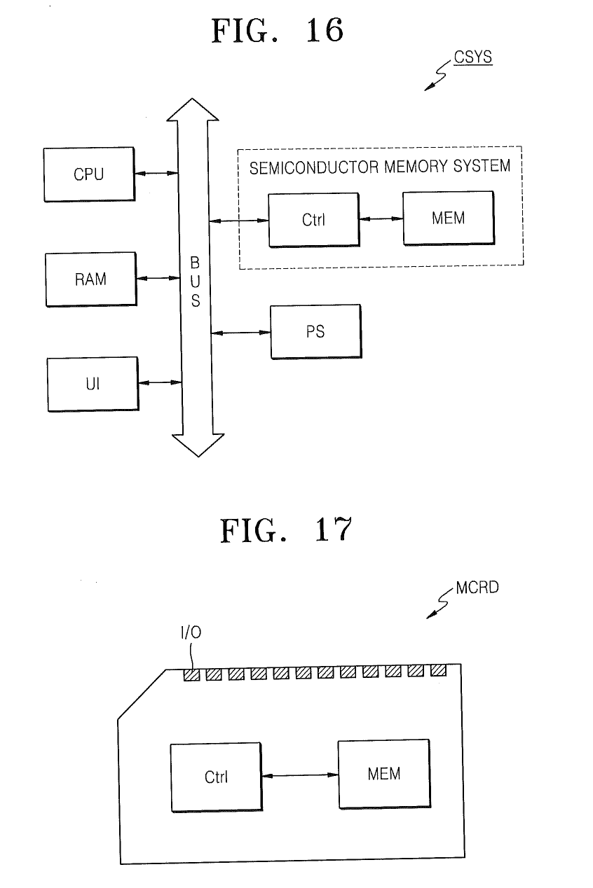

FIG. 16 is a block diagram of a computing system CSYS that includes one of the semiconductor memory systems according to embodiments of the inventive concept (e.g., MSYS-1 through MSYS-10).

As shown in FIG. 16, the computing system CSYS includes a processor CPU, a user interface UI, and the semiconductor memory system, each of which are electrically connected to a bus BUS. The semiconductor memory system includes a controller Ctrl and a semiconductor memory device MEM. The semiconductor memory device MEM may store N-bit data that is processed or to be processed by the processor CPU, wherein N is an integer equal to or above 1.

The computing system CSYS may further include a power supply device PS. Also, when the semiconductor memory device MEM is a flash memory device, the computing system CSYS may further include a volatile memory device, such as a random access memory (RAM).

When the computing system CSYS is a mobile device, the computing system CSYS may further include a battery for supplying an operating voltage to the computing system CSYS, and a modem, such as a baseband chipset. The computing system CSYS may further include an application chipset, a camera image processor (CIS), a mobile dynamic random access memory (DRAM), or the like.

FIG. 17 is a schematic diagram of a memory card MCRD according to still further embodiments of the inventive concept.

Referring to FIG. 17, the memory card MCRD includes a controller Ctrl (which is generically labeled) and a semiconductor memory device MEM. The controller Ctrl controls data to be written to, or read from, the semiconductor memory device MEM, in response to a request of an external host (not shown), received through an input and output unit I/O. When the semiconductor memory device MEM of FIG. 17 is a flash memory device, the controller Ctrl may also control an erasing operation on the semiconductor memory device MEM. In order to perform such control operations, the controller Ctrl of the memory card MCRD may include, for example, a RAM and interface units (not shown), which interface with hosts and the semiconductor memory device MEM. The controller Ctrl of the memory card MCRD may be, for example, any one of the controllers Ctrl-1 through Ctrl-6 illustrated in FIGS. 6 through 15. Likewise, the semiconductor memory device MEM of the memory card MCRD may be, for example, any one of the semiconductor memory devices MEM-1 through MEM-7 of FIGS. 6 through 15.

The memory card MCRD of FIG. 17 may be, for example, a compact flash card (CFC), a microdrive, a smart media card (SMC), a multimedia card (MMC), a security digital card (SDC), a memory stick, or a universal serial bus (USB) flash memory driver.

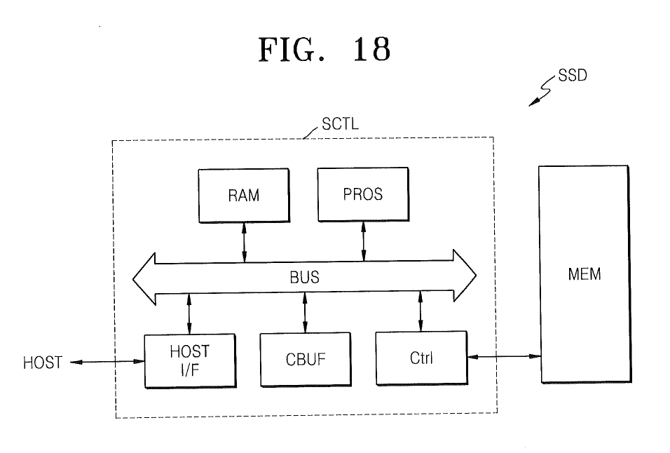

FIG. 18 is a block diagram of a solid state drive (SSD) according to embodiments of the inventive concept.

Referring to FIG. 18, the SSD includes an SSD controller SCTL and a semiconductor memory device MEM. The SSD controller SCTL may include a processor PROS, a RAM, a cache buffer CBUF, and a controller Ctrl, which are connected to a bus BUS. The processor PROS controls the controller Ctrl to transmit and receive data to and from the semiconductor memory device MEM, in response to a request (command, address, or data) of a host (not shown). The processor PROS and the controller Ctrl of the SSD may be realized in one ARM processor. Data required to operate the processor PROS may be loaded in the RAM.

A host interface HOST I/F transmits a received request of the host to the processor PROS, or transmits received data from the semiconductor memory device MEM to the host. The host interface HOST I/F may interface with the host by using various interface protocols, such as USB, man machine communication (MMC), peripheral component interconnect-express (PCI-E), serial advanced technology attachment (SATA), parallel advanced technology attachment (PATA), small computer system interface (SCSI), enhanced small device interface (ESDI), and intelligent drive electronics (IDE). The data that is received from or that is to be transmitted to the semiconductor memory device MEM may be temporarily stored in the cache buffer CBUF. The cache buffer CBUF may be an SRAM, or the like.

The controller Ctrl and the semiconductor memory device MEM included in the SSD may be respectively any one of the controllers and the semiconductor memory devices of FIGS. 6 through 15.

The semiconductor memory devices according to the above embodiments of the inventive concept may be installed by using a package having any shape. For example, the semiconductor memory device may be installed by using a package, such as package on package (PoP), ball grid arrays (BGAs), chip scale packages (CSPs), plastic leaded chip carrier (PLCC), plastic dual in-line package (PDIP), die in waffle pack, die in wafer form, chip on board (COB), ceramic dual in-line package (CERDIP), plastic metric quad flat pack (MQFP), thin quad flat pack (TQFP), small outline integrated chip (SOIC), shrink small outline package (SSOP), thin small outline package (TSOP), thin quad flat pack (TQFP), system in package (SIP), multi chip package (MCP), wafer-level fabricated package (WFP), or wafer-level processed stack package (WSP).

Terms used herein are for descriptive purposes only, and are not used to limit the scope of embodiments of the inventive concept.

For example, the embodiments above are primarily described with respect to the programming operation on the semiconductor memory system, but it will be appreciated that corresponding methods of reading data may likewise be performed. In order to read data stored in the memory cell array MA of FIG. 1 or the like, the second randomizer RAN2 may output first random data RAND1′ by derandomizing second random data RAND2′ stored in the memory cell array MA, and the first randomizer RAN1 may output the read data RDTA by derandomizing the first random data RAND1′ received from the second randomizer RAN2.

Also, the first period of the first sequence Seq1 and the second period of the second sequence Seq2 are different in the above embodiments, but the inventive concept is not limited thereto. Even if the first and second periods are the same (y=0 in FIG. 4B), the semiconductor memory systems include the first randomizer RAN1 for generating the first sequence Seq1 and the second randomizer RAN2 for generating the second sequence Seq2 in different areas (for example, one in the controller and the other one in the semiconductor memory device), and thus, randomness may be effectively realized.

While the inventive concept has been particularly shown and described with reference to exemplary embodiments thereof, it will be understood that various changes in form and details may be made therein without departing from the spirit and scope of the following claims.

What is claimed is:

1. A semiconductor memory system comprising a semiconductor memory device having a storage area, the semiconductor memory system comprising:
a first randomizer that is configured to change program data that is to be programmed into the storage area to first random data using a first sequence that has a first period; and
a second randomizer that is configured to change the first random data to second random data using a second sequence that has a second period that is different from the first period.

2. The semiconductor memory system of claim 1, further comprising a memory controller that includes the first randomizer, wherein the semiconductor memory device includes the second randomizer.

3. The semiconductor memory system of claim 1, further comprising a memory controller that includes both the first and second randomizers.

4. The semiconductor memory system of claim 1, wherein the semiconductor memory device includes both the first and second randomizers.

5. The semiconductor memory system of claim 1, wherein the first period is longer than the second period.

6. The semiconductor memory system of claim 1, wherein the first period is shorter than the second period.

7. The semiconductor memory system of claim 1, wherein the second random data is programmed in the storage area.

8. The semiconductor memory system of claim 1, wherein the first randomizer outputs the first random data by performing an exclusive OR operation on the first sequence and the program data, and the second randomizer outputs the second random data by performing an exclusive OR operation on the second sequence and the first random data.

9. The semiconductor memory system of claim 1, wherein the first randomizer includes a first binary randomizer for generating a first sequence from a first seed, and the second randomizer includes a second binary randomizer for generating the second sequence from a second seed.

10. The semiconductor memory system of claim 9, wherein the first and second seeds are different from each other,

11. The semiconductor memory system of claim 9, wherein at least one of the first randomizer and the second randomizer includes at least two sub-randomizers.

12. The semiconductor memory system of claim 1, wherein the semiconductor memory device, a solid state drive and the storage area together comprise a nonvolatile memory device, the semiconductor memory system further including a solid state drive controller that is configured to control programming and reading of the nonvolatile memory device.

13. The semiconductor memory system of claim 12, wherein the first randomizer is included in the solid state drive controller, and the second randomizer is included in the nonvolatile memory device.

14. A semiconductor memory device comprising a randomizer that is configured to receive first random data that is obtained by randomizing program data using a first sequence that has a first period and to change the received first random data to second random data using a second sequence that has a second period that is different from the first period.

15. The semiconductor memory device of claim 14, wherein the randomizer outputs the second random data by performing an exclusive OR operation on the second sequence and the first random data.

16. A semiconductor memory system comprising:
a memory controller that includes a first randomizer that is configured to change program data to first random data using a first sequence that has a first period; and
a NAND flash memory device that includes a second randomizer that is configured to change the first random data to second random data using a second sequence that has a second period.

17. The semiconductor memory system of claim 16, wherein the first and second periods are the same.

18. The semiconductor memory system of claim 16, wherein the first and second periods are different from each other.

19. A method of randomizing program data that is to be stored in a semiconductor storage device, the method comprising:
using at least a first randomizer that uses a first sequence having a first period to convert the program data into first randomized data; and
inputting the first randomized data to at least a second randomizer that uses a second sequence having a second period that is different than the first period to convert the first randomized data into second randomized data.

20. The method of claim 19, wherein the first randomizer is initialized using a first seed and the second randomizer is initialized using a second seed that is different than the first seed.

21. The method of claim 20, wherein the first randomizer is configured to update the first seed in one of a page unit, a block unit or a sector unit, and the second randomizer is configured to update the second seed in a manner different than the first randomizer.
